(19) United States
(12) Patent Application Publication
(10) Pub. No.: US 2026/0233901 A1
(43) Pub. Date: Aug. 13, 2026

(54) CLOSURE CAP MADE OF PLASTIC

(71) Applicant: ALPLA WERKE ALWIN LEHNER GMBH & CO. KG, Hard (AT)

(72) Inventors: Christof NEZTER, Dornbirn (AT); Kaspar FELIX, Hohenems (AT); Pascal BEHR, Schwarzach (AT); Sabrina ADAMI-SCHADLER, Hohenweiler (AT); Valentin REZSNYAK, Lustenau (AT); Denis SCHEIBENSTOCK, Hohenems (AT)

(21) Appl. No.: 19/469,594

(22) PCT Filed: Mar. 26, 2024
(86) PCT No.: PCT/EP2024/058044

§ 371 Date: Sep. 26, 2025

(30) Foreign Application Priority Data
Mar. 28, 2023 (CH) CH000343/2023

(51) Int. Cl. B65D 41/04; B29C 45/00; B29K 67/00; B29L 31/56

(52) U.S. Cl. CPC B65D 41/0414; B29C 45/0001; B29K 2067/003; B29L 2031/565; B65D 2401/20

(57) ABSTRACT

A closure cap made of PET for closing a container made of PET, including a circular head plate, a cylindrical threaded part surrounding the head plate and having an open edge and an inner thread, and a sealing cone protruding on the inside of the head plate; a connection ring is provided between the sealing cone and the head plate, which connection ring has a wall thickness of between 0.2 and 0.4 mm and connects the sealing cone to the head plate.

### FIELD OF THE INVENTION

The invention relates to a closure cap made of plastics material according to the preamble of claim 1, a combination of the closure cap and a container made of PET according to the preamble of claim 9, and a method for making such a closure cap according to the preamble of claim 12.

### PRIOR ART

Polyethylene terephthalate (PET) is polar, which means strong intermolecular forces are present. The molecule is also linear in structure without cross-links. It is therefore suitable for making hard objects which have high breaking strength, such as stable PET bottles which can withstand high internal pressures. The hardness and stiffness can be further increased by stretching a preform made of PET in the radial and axial directions. Because of its hardness, PET is unsuitable as a closure cap, as a closure cap generally requires softer and therefore better sealing plastics material. Therefore, polyolefins are mainly used to make closure caps. However, compared to PET, a disadvantage of polyolefins is their limited recyclability when they are of food-safe quality.

Experiments are therefore being carried out using injection molds which have improved thermal conductivity and thus allow the temperature in the injection mold to be raised and lowered rapidly. This is intended to make it possible to inject PET into the mold and demold it from the mold.

### OBJECT OF THE INVENTION

The disadvantages of the described prior art give rise to the problem of creating a plastics closure which can be made from the identical PET material as the container it closes and which reliably seals the container without the need for an expensive injection mold to make the closure.

### DESCRIPTION

In a closure cap made of PET for closing a container made of PET, the solution to the problem presented is achieved by the features detailed in the characterizing portion of claim 1. The dependent claims relate to developments and/or advantageous alternative embodiments.

The invention is characterized in that a connection ring is provided between the sealing cone and the head plate, which connecting ring has a wall thickness of between 0.2 and 0.4 mm and connects the sealing cone to the head plate, and in that the closure cap, together with the sealing cone and the connection ring, is made of PET. The very thin-walled connection ring gives the sealing cone a flexibility comparable to that of HDPE and PP. This means that the sealing cone can rest smoothly against the inside of a container neck and a reliable seal between the sealing cone and the container neck is possible. This is despite the fact that the cap is made entirely of comparatively hard and brittle PET.

In a preferred embodiment, the inner thread has a surface roughness of between 0.1 μm and 0.2 μm and preferably between 0.14 μm and 0.16 μm. This prevents the inner thread from being too smooth and therefore running the risk of becoming welded to the outer thread of the container neck when it is first screwed onto the container neck. Friction welding, caused by fast-running capping machines in the packaging industry, is prevented by the increased roughness of the inner thread.

It has proven to be useful if the outside of the sealing cone is polished and has a surface roughness of less than 0.15 μm and preferably less than 0.02 μm. The smooth surface improves the sealing effect of the sealing cone when said sealing cone rests on the inside of the container neck.

The closure cap expediently comprises holding elements on which retaining elements can engage when the closure cap is demolded from an injection mold. Demolding the hard PET closure in the conventional way is difficult because the threaded part is not easily deformable due to its wall thickness and the inner thread represents an intersection of more than 0.4 mm. The holding elements allow the closure cap to be removed by rotating the injection mold core. The holding elements can prevent the cap from rotating when the core is unscrewed from the closure cap. The holding elements can be holes or ribs or notches. Notches are preferable because they can be made during injection molding using a simple mold.

Conveniently, the closure cap is uncolored. This means the cap is transparent or white. This means that the cap does not introduce any disruptive color pigments during recycling.

In a further particularly preferred embodiment of the invention, the closure cap is made of up to 100% food-safe rPET. Compared to PP (polypropylene) or HDPE (high density polyethylene), which are plastics materials mainly made to make closure caps, PET can be recycled very well, even into high-quality food-safe rPET. Closure caps according to the invention comprising a thin-walled connection ring can be made from this rPET.

The closure cap expediently comprises a guarantee ring which is held on the open edge of the threaded part by a plurality of predetermined breaking links. This means that the cap can be immediately identified as having been opened for the first time if the predetermined breaking links are broken.

A further aspect of the invention relates to a combination of the closure cap described above and a container onto which the cap is screwed, wherein the outer thread of the container neck has a surface roughness of between 0.1 μm and 0.2 μm and preferably between 0.14 μm and 0.16 μm. As already explained above, this prevents the outer and inner threads from becoming friction welded during rapid screwing onto one another for the first time using fully automatic capping machines.

In a further preferred embodiment, the inside of the container neck has a surface roughness of between 0.1 μm and 0.2 μm and preferably between 0.14 μm and 0.16 μm. This also prevents friction welding of the sealing cone to the container neck, even if the sealing cone is polished in order to improve the sealing function.

In a particularly preferred embodiment of the invention, the outer diameter of the sealing cone, after a shrinkage of the closure cap of between 0.4% and 0.6%, is between 0.4 and 0.6 mm larger than the inner diameter of the container neck when screwed onto the container neck. PET always exhibits shrinkage, which must be taken into account when dimensioning the sealing cone, so that the outer diameter of the sealing cone does not become too small during contraction and the closure does not become leaky.

A further aspect of the invention relates to a method for making the described closure cap from PET. The method is characterized in that the mold temperature of the injection mold during injection molding is between 12 and 52° C., preferably between 20 and 40° C. and particularly preferably between 25 and 35° C. Surprisingly, at these low temperatures, the residual stress of the closure can be kept low and the closure does not become brittle. Stress cracks which grow larger over time and lead to deformation of the sealing cone and leaks are prevented by the selected mold temperature.

In a further particularly preferred embodiment of the invention, the cycle time between injecting the molten PET and demolding the closure cap is less than 15 s, preferably between 6 and 12 s and particularly preferably between 8 and 12 s, resulting in the closure cap not having time to contract onto the injection core. These short cycle times prevent the contracting material from developing tensile stresses in height and circumference, which could lead to microscopic cracks (crazes) that damage the material through embrittlement. These stress cracks become larger over time, causing material embrittlement to increase. Frozen stresses that should be avoided also lead over time to deformation and a corresponding shrinkage of the sealing cone and, subsequently, to leakage.

Preferably, the residence time of the PET in the injection extruder is less than 350 s and preferably 50 to 250 s, the temperature of the PET in the injection extruder being less than 300° C. and preferably between 270 to 285° C. Degradation of the PET material, which leads to its embrittlement, is prevented by combining the short residence time with the selected temperature.

In a further preferred embodiment of the invention, the molten PET is injected from an injection extruder into the mold at an injection speed between 15 and 35 g/s and an injection pressure of more than 1000 bar and preferably between 1500 and 3500 bar. The high injection speed enables the thin-walled PET closure cap, which has a minimum wall thickness of the connection ring of 0.2 mm, to fill the entire cavity of the injection mold without the PET material freezing and the cavity in the region of the connection ring remaining unfilled. The high injection pressure enables the high injection speed.

The invention is also preferably characterized in that the holding pressure is reduced as rapidly as possible after reaching the filling point to a pressure below 1000 bar and preferably to below 500 bar. The rapid pressure reduction prevents crystallization of the PET material, which occurs at high injection pressures and leads to undesirable embrittlement.

In a further particularly preferred embodiment of the invention, the injection core is rotated out of the closure cap in order to demold the closure cap, retaining elements preventing the closure cap from rotating along with the injection core. For forced demolding of the comparatively hard PET closure cap, the threaded part is too thick and the undercuts of the inner thread are too deep. Rotating out the core therefore provides a replacement demolding method for forced demolding, which is possible and common for caps made of PP or HDPE.

Further advantages and features will become apparent from the following description of an embodiment of the invention with reference to the schematic drawings. In the figures, in a representation that is not to scale:

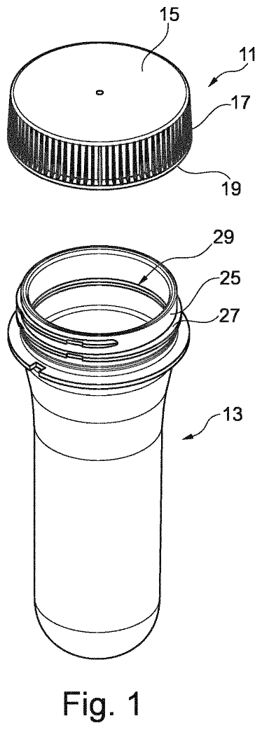

FIG. 1: a closure cap and a container (preform) onto which the closure cap can be screwed in an axonometric view;

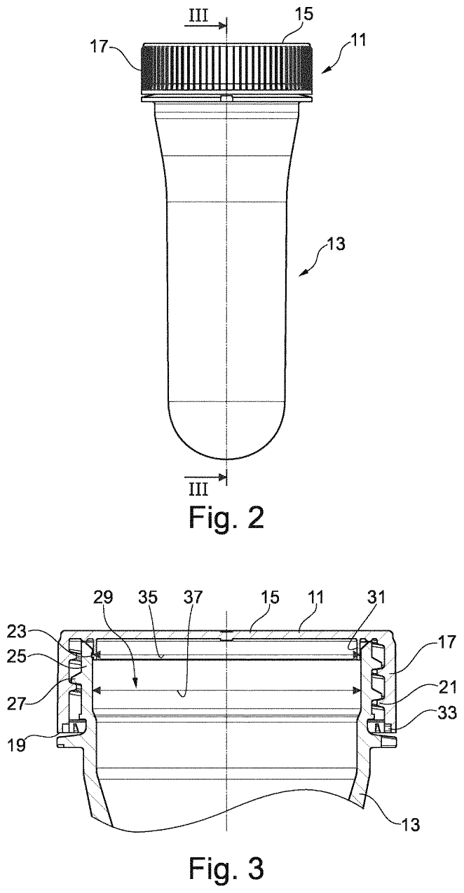

FIG. 2: the closure cap screwed onto the container in a side view;

FIG. 3: a sectional view along the section line III-III of FIG. 2 and

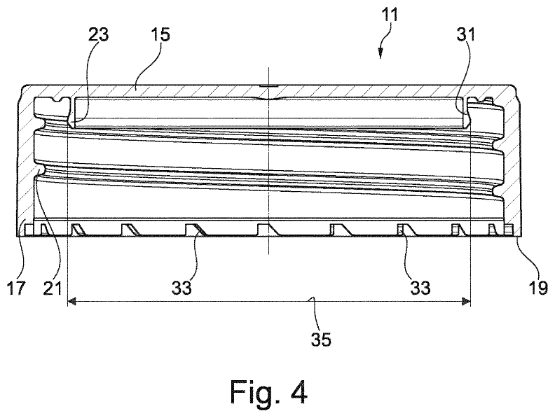

FIG. 4: a sectional view through the closure cap.

FIG. 1 to 4 show a closure cap made of PET, which closure cap is denoted as a whole by the reference sign 11. The closure cap 11 is intended to be screwed onto a container 13. The container is also made of PET and is shown in FIGS. 1 to 3 as a preform 13, which is stretch blow molded to form a container or bottle.

The cap 11 comprises a circular head plate 15 and a cylindrical threaded part 17 surrounding the head plate 15. The threaded part 17 has an open edge 19 and an inner thread 21. A sealing cone 23 protrudes on the inside of the head plate 15. The container 13 comprises a container neck 25 having an outer thread 27 which cooperates with the inner thread 21. The container neck 25 delimits a container opening 29 through which filling material is poured into the container 13 and also poured out.

When screwed on, the sealing cone 23 penetrates into the container opening 29 and thereby seals the opening 29 against the cap 11. This allows the cap 11 to reliably seal the opening 29.

A connection ring 31 is provided between the sealing cone and the head plate. The connection ring 31 has a wall thickness of between 0.2 and 0.4 mm and connects the sealing cone 23 to the head plate 15. Due to the very small wall thickness of the connection ring 31, the sealing cone remains flexible and can seal the opening, even though said sealing cone is made of hard PET, which is less flexible compared to HDPE or PP. Due to the provision of the connection ring 31, the sealing cone 23 is similarly soft to a closure made of PP or HDPE.

The inner thread 21 and the outer thread 27 have a surface roughness of between 0.14 and 0.16 μm. This high surface roughness ensures that the threads 21 and 27 do not become friction welded when the closure cap is screwed on, and that a torque enabling a reliable sealing of the opening 29 can be applied. The surface roughness of the inside of the container neck 25 is also between 0.14 and 0.16 μm, so that the sealing cone does not become friction welded to the container neck.

The closure cap 11 comprises notches 33, on which retaining elements can engage when the closure cap 11 is demolded from an injection mold. As a result, the closure cap 11 can be demolded from the injection mold by rotating the injection core, and can be demolded despite undercuts and the low deformability of PET.

The outer diameter 35 of the sealing cone must be slightly larger than the inner diameter 37 of the container neck in order to achieve a reliable sealing function. This excess is also called prestress. Because PET shrinks after injection molding, this must be taken into account to obtain the correct prestress. Otherwise, the outer diameter 35 of the sealing cone becomes too small due to the unconsidered shrinkage and can no longer seal the container neck 25. The shrinkage of the closure cap is approximately 0.5%, which means that the outer diameter of the sealing cone shrinks by approximately 0.1 to 0.4 mm. When the shrinkage is complete, the excess of the outer diameter 35 when screwed onto the container neck is 0.4 to 0.6 mm compared to the inner diameter 37 of the container neck. Because the shrinkage or contraction process is complete, this excess is sufficient to reliably seal the container neck using the sealing cone.

The closure cap 11 is preferably uncolored or transparent. This makes the closure cap particularly easy to process alongside the container 13 to form a container made of rPET.

The method for making the described closure cap in an injection mold has the following distinguishing features, which reduce the brittleness of the PET material and thus contribute to making PET a suitable material for closure caps:

The mold temperature of the injection mold during injection molding is between 12 and 52° C., preferably between 20 and 40° C., and particularly preferably between 25 and 35° C. This allows the residual stress of the closure 11 to be kept low, and the closure does not become brittle. Stress cracks which grow larger over time and lead to deformation of the sealing cone 23 and leaks are prevented by the selected mold temperature.

The cycle time between injecting the molten PET and demolding the closure cap is preferably between 6 and 12 s and particularly preferably between 8 and 12 s. As a result, the closure cap does not have time to contract onto the injection core. Contracting onto the injection core would lead to undesirable tensile stresses in the cap, which are prevented by the selected cycle times.

The degradation of the PET material of the cap 11 and the associated brittleness could be achieved by reducing the residence time in the injection extruder to ideally 50 to 250 s in combination with a temperature preferably between 270 and 285° C. However, such low melt temperatures can lead to the PET material freezing. Therefore, the injection speed into the injection mold is selected to be between 15 and 35 g/s. In order to be able to inject the connection ring 31 so that it has the very small wall thickness of preferably 0.25 mm and fill the injection mold in the region of the connection ring 31, a high injection pressure is selected. The injection pressure is preferably between 1500 and 3500 bar.

A disadvantage of the high injection pressure is that the injected PET material orients itself and crystallizes at the molecular level, particularly around the injection point at the holding pressure. Crystallization leads to undesirable hardening and increased brittleness of the PET material. To avoid crystallization, the holding pressure was reduced immediately after reaching the filling point to pressures below 1000 bar.

Although it is made of PET, the closure cap 11 has a sufficient sealing function to seal the container opening 29. Advantageously, the closure cap 11 can also be made of food-safe rPET, because a flexible sealing cone can also be made of rPET. As a result, the closure cap 11 is suitable for closing a container 13 or a bottle into which beverages are poured.

1.-17. (canceled)

18. A closure cap made of a plastics material, for closing a container comprising polyethylene terephthalate (PET), the closure cap comprising:
a circular head plate,
a cylindrical threaded part surrounding the circular head plate, the cylindrical threaded part comprising an open edge and an inner thread, and
a sealing cone protruding on an inner side of the head plate, wherein
a connection ring interposed between the sealing cone and the circular head plate, the connection ring having a wall thickness of between 0.2 and 0.4 mm and operatively couples the sealing cone to the circular head plate and
the closure cap, together with the sealing cone and the connection ring, is made of PET.

19. The closure cap according to claim 18, wherein the inner thread has a surface roughness of between 0.1 μm and 0.2 μm.

20. The closure cap according to claim 18, wherein an outside side of the sealing cone is polished and has a surface roughness of less than 0.15 μm.

21. The closure cap according to claim 18, wherein the closure cap further comprises holding elements on which retaining elements can engage when the closure cap is demolded from an injection mold.

22. The closure cap according to claim 21, wherein the holding elements comprise notches disposed on an open edge of the cylindrical threaded part.

23. The closure cap according to claim 18, wherein the closure cap is colorless.

24. The closure cap according to claim 18, wherein the closure cap comprises 100% food-safe recycled polyethylene terephthalate (rPET).

25. The closure cap according to claim 18, wherein the closure cap comprises a guarantee ring which is coupled on the open edge of the cylindrical threaded part by a plurality of predetermined breaking links.

26. In combination:
a closure cap made of a plastics material, for closing a container comprising polyethylene terephthalate (PET), the closure cap comprising:
a circular head plate,
a cylindrical threaded part surrounding the circular head plate, the cylindrical threaded part comprising an open edge and an inner thread, and
a sealing cone protruding on an inner side of the head plate, wherein
a connection ring interposed between the sealing cone and the circular head plate, the connection ring having a wall thickness of between 0.2 and 0.4 mm and operatively couples the sealing cone to the circular head plate and
the closure cap, together with the sealing cone and the connection ring, is made of PET, and
a container made of PET comprising a container neck having an outer thread onto which the closure cap is selectively screwed on and off,
wherein the outer thread has a surface roughness of between 0.1 μm and 0.2 μm.

27. The combination according to claim 26, wherein an inner side of the container neck has a surface roughness of between 0.1 μm and 0.2 μm.

28. The combination according to claim 26, wherein an outer diameter of the sealing cone, after a shrinkage of the closure cap of between 0.4% and 0.6%, is between 0.4 and 0.6 mm larger than the inner diameter of the container neck when screwed onto the container neck.

29. A method for making a closure cap in an injection mold comprising a die and an injection core, the closure cap being made of a plastics material, for closing a container comprising polyethylene terephthalate (PET), the closure cap comprising:
a circular head plate,
a cylindrical threaded part surrounding the circular head plate, the cylindrical threaded part comprising an open edge and an inner thread, and
a sealing cone protruding on an inner side of the head plate, wherein
a connection ring interposed between the sealing cone and the circular head plate, the connection ring having a wall thickness of between 0.2 and 0.4 mm and operatively couples the sealing cone to the circular head plate and
the closure cap, together with the sealing cone and the connection ring, is made of PET,
the method comprising heating the injection mold during injection molding of molten PET to a temperature of between 12 and 52° C.

30. The method according to claim 29, wherein a cycle time between injecting the molten PET and demolding the closure cap is less than 15 s, resulting in the closure cap not having time to contract onto the injection core.

31. The method according to claim 29, wherein a residence time of the PET in an injection extruder is less than 350 s, and the temperature of the PET in the injection extruder being less than 300° C.

32. The method according to claim 29, wherein the molten PET is injected from an injection extruder into the mold at an injection speed between 15 and 35 g/s and an injection pressure of more than 1000 bar.

33. The method according to claim 32, wherein the holding pressure is reduced as rapidly as possible after a filling point reaches a pressure below 1000 bar.

34. The method according to claim 29, wherein for demolding the closure cap, the injection core is rotated out of the closure cap, and retaining elements prevent the closure cap from rotating alongside the injection core.
